(19) United States
(12) Patent Application Publication
(10) Pub. No.: US 2024/0100509 A1
(43) Pub. Date: Mar. 28, 2024

(54) CATALYSTS

(71) Applicant: The Regents of the University of California, Oakland, CA (US)

(72) Inventors: Jinyong LIU, Riverside, CA (US); Jinyu GAO, Riverside, CA (US)

(73) Assignee: The Regents of the University of California, Oakland, CA (US)

(21) Appl. No.: 18/372,535

(22) Filed: Sep. 25, 2023

Related U.S. Application Data
(60) Provisional application No. 63/410,083, filed on Sep. 26, 2022.

(51) Int. Cl. B01J 23/46; B01J 23/44; C02F 1/70

(52) U.S. Cl. CPC B01J 23/462; B01J 23/44; C02F 1/705

(57) ABSTRACT

The invention provides a catalyst comprising 1) Ru⁰ and 2) Pd⁰, Pt⁰, Rh⁰, or Ir⁰, on a solid support. The catalyst is useful for water purification applications. In particular, the catalyst is useful for reducing ClO₃⁻ and ClO₂⁻ from water. The invention also provides catalysts that are useful for reducing nitrate in a water supply and methods for their use.

### STATEMENT REGARDING FEDERALLY SPONSORED RESEARCH

This invention was made with government support under 1932942 awarded by the National Science Foundation. The government has certain rights in the invention.

### PRIORITY

This application claims priority to U.S. Provisional Patent Application No. 63/410,083, filed 26 Sep. 2022. The entire content of U.S. Provisional Patent Application No. 63/410,083 is hereby incorporated herein by reference.

### BACKGROUND

More than four million tons of sodium chlorate (NaClO₃) are manufactured annually worldwide for pulp bleaching, weed control, and pyrotechnics, et al., (researchandmarkets.com/reports-/5323457 (2020)). Water disinfection using hypochlorite or chlorine dioxide and various electrochemical processes (e.g., chloralkali, water splitting, seawater valorization, and wastewater treatment) also generate ClO₃⁻ as a byproduct (Gorzalski, A. S. & Spiesman, A. L. J. Am. Water Works Assoc. 107, E613-E626 (2015); Karlsson, R. K. & Cornell, A. Chem. Rev. 116, 2982-3028 (2016); Lakshmanan, S. & Murugesan, T., Clean Technol. Environ. Policy 16, 225-234 (2014); Park, H., et al., J. Phys. Chem. C 113, 370, 7935-7945 (2009); Kumar, A., et al., Nat. Catal. 373, 2, 106 (2019); Cho, K. et al., Environ. Sci. 376, Technol. 48, 2377-2384 (2014); Ibl, N. & Landolt, D. J., Electrochem. Soc. 115, 713-720 (1968); and Landolt, D. & Ibl, N., Electrochim. Acta 15, 1165-1183 (1970)). Not surprisingly, ClO₃⁻ enters the water environment, dairy supply chain, and agricultural products.

When ingested, ClO₃⁻ can cause red blood cell rupture and thyroid gland malfunction (Mastrocicco, M., et al., Environ. Pollut. 231, 383, 1453-1462 (2017); Rosemarin, A., et al., Environ. Pollut. 85, 3-13 (1994); Stauber, J. L. Aquat. Toxicol. 41, 213-227 387 (1998); McCarthy, W. P. et al. Compr. Rev. Food Sci. Food Saf. 17, 1561-1575 (2018); Kettlitz, B. et al. Food Addit. Contam. Part A 33, 392, 968-982 (2016); Li, M. et al. Environ. Int. 158, 106939 (2022); Liu, Q., et al., Food Addit. Contam. 397, Part A 38, 2045-2054 (2021); EFSA CONTAM Panel. EFSA J. 13, 4135 (2015); Smith, D. J. & Taylor, J. B. J. Agric. Food Chem. 59, 1598-1606 (2011); and Panseri, S. et al. Food Chem. 330, 127205 (2020)). The World Health Organization, European Union, and China have set the limit of ClO₃⁻ concentration in drinking water at 0.7 mg L⁻¹. The United States has set the health reference level at 0.21 mg L⁻¹ and the minimum reporting level at 0.02 mg L⁻¹. Hence, a highly efficient ClO₃⁻ reduction method would be of significant value.

Although the ClO₃⁻ challenge for water systems has been recently recognized (Gorzalski, A. S. & Spiesman, A. L. J. Am. Water Works Assoc. 107, E613-E626 (2015); and Alfredo, K., et al., J. Am. Water Works Assoc. 107, 187 (2015)), research efforts for ClO₃⁻ reduction are limited. Platinum group metal (PGM) catalyzed hydrogenation provides a clean degradation route:

ClO₃⁻+3H₂→Cl⁻+3H₂O.

Besides, the ubiquitous use of PGM in automotive catalytic converters (Saguru, C., Ndlovu, S. & Moropeng Hydrometallurgy 182, 44-56 (2018)) and the negligible PGM leaching under the H₂ atmosphere (De Corte, S., et al., Microb. Biotechnol. 5, 5-17 (2012)) rationalize the application of PGM for water treatment (Gao, J. et al., ACS ES&T Eng. 1, 562-570 (2021); Chaplin, B. P. et al., Environ. Sci. Technol. 46, 3655-3670 (2012); and Ren, C., et al., ACS ES&T Eng., 2, 181-188 (2022)). Ren, C., et al., ACS ES&T Eng., 2, 181-188 (2022)). However, most reported ClO₃⁻ reduction catalysts (e.g., Rh (Van Santen, et al., U.S. Pat. No. 6,270,682 (2001)), Ir (Kuznetsova, L. I. et al., Appl. Catal. A: Gen. 427, 8-15 (2012)), Pd (Ye, T. et al., ACS Applied Nano Materials 1, 6580-6586 (2018)), Mo—Pd (Ren, C. et al., ACS Catal. 10, 8201-8211 (2020)) exhibit maximum activity in acidic conditions. The proton-assisted mechanisms severely restrict the catalytic performance around neutral pH. If acidification is not feasible, a 10-80× dose of PGM catalyst is necessary to compensate the activity loss and maintain the same reaction rate as at pH≤4 (FIG. 1).

Currently there is a need for catalysts that are useful for water purification applications. There is also a need for facile and commercially feasible methods for preparing such catalysts. In particular, there is a need for catalysts that can be used for water purification applications at neutral or alkaline pH.

### SUMMARY

To address this major challenge and advance reductive catalysis for water treatment, the invention (i) achieves the unprecedented high activity of ClO₃⁻ reduction at pH 7 by harnessing the unique functions of Ru and Pd, Pt, Rh, or Ir, (ii) develops a rapid and convenient preparation method for Ru⁰ catalyst with metal contents as low as 0.1 wt %, (iii) elucidates the structure and synergy of the metals, and (iv) showcases the catalyst robustness under practical and challenging scenarios.

The invention provides a facile method to prepare functional Ru catalysts on a porous support. The catalysts are useful to reduce aqueous chlorate for water and waste treatment at or near neutral pH, and to reduce aqueous chlorate byproduct in chloralkali brine.

In one aspect, the invention provides a catalyst comprising 1) Ru⁰ and 2) Pd⁰, Pt⁰, Rh⁰, or Ir⁰, on a solid support.

In another aspect the present invention provides a method comprising contacting a water sample that comprises ClO₃⁻ with a catalyst of the invention under conditions such that at least some of the ClO₃⁻ is reduced to Cl⁻. In one embodiment, at least 50% of the ClO₃⁻ is reduced to Cl⁻. In another embodiment, at least 70% of the ClO₃⁻ is reduced to Cl⁻. In another embodiment, at least 80% of the ClO₃⁻ is reduced to Cl⁻. In another embodiment, at least 90% of the ClO₃⁻ is reduced to Cl⁻. In another embodiment, at least 90% of the ClO₃⁻ is reduced to Cl⁻. In another embodiment, at least 95% of the ClO₃⁻ is reduced to Cl⁻. In another embodiment, at least 99% of the ClO₃⁻ is reduced to Cl⁻.

In another aspect the present invention provides a method comprising sequentially reducing 1) Pd^{II}, Pt^{II}, Rh^{III}, or IR^{III} and 2) Ru^{III} on a support to provide a catalyst.

In another aspect the present invention provides a method comprising sequentially reducing in situ, Pd^{II}, Pt^{II}, Rh^{III}, or IR^{III} and Ru^{III} on a support to provide an Ru—Pd/C catalyst.

In another aspect the present invention provides a method comprising sequentially reducing Pd^{II} and Ru^{III} in situ on a support to provide a catalyst.

In another aspect the present invention provides a method comprising reducing Pd^{II} to Pd⁰ on a support that comprises carbon and reducing Ru^{III} to Ru⁰ on the support to provide a Ru—Pd/C catalyst.

In another aspect the present invention provides a catalyst prepared according to a method of the invention.

In another aspect the present invention provides a method for preparing a catalyst as described herein.

In another aspect the present invention provides a method comprising contacting a water sample that comprises NO₃⁻ with a catalyst comprising 1) Ru⁰ and 2) Pd⁰, Pt⁰, Rh⁰, or Ir⁰, on a solid support, under conditions such that at least some of the NO₃⁻ is reduced to NH₄⁺.

In another aspect the present invention provides a method comprising contacting a water sample that comprises NO₃⁻ with a catalyst that comprises in situ reduced Ru particles and another metal, under conditions such that at least some of the NO₃⁻ is reduced to NH₄⁺. In one embodiment, the catalyst comprises Os—Ru/C, Ru—Ru/C, Ru—Rh/C, Ru—Ir/C, Ru—Pt/C or Ru—Pd/C.

In another aspect the present invention provides a method comprising contacting a water sample that comprises NO₃⁻ with a catalyst that comprises Ru—Pd/C or In—Pd/C, under conditions such that at least some of the NO₃⁻ is reduced to NH₄⁺.

In another aspect the present invention provides processes and intermediates disclosed herein.

### BRIEF DESCRIPTION OF THE DRAWINGS

FIG. 1 shows performance data for ClO₃⁻ reduction by a Ru—Pd/C catalyst of the invention and other catalysts.

FIGS. 2A-2I: The reduction of (A) aqueous Pd^{II} (360 mg L⁻¹ Pd from Na₂ PdCl₄), (B) aqueous Ru^{III} (40 mg L⁻¹ Ru from RuCl₃), and (C) first Pd^{II} (40 mg L⁻¹) then Ru^{III} (40 mg L⁻¹) by 1 atm H₂ (blown from the needle tip 5 mm above the liquid) at 20° C. (D) The all-in situ procedure for Ru—Pd/C preparation. Profiles of ClO₃⁻ reduction by (E) Ru—Pd/C and (F) Ru/C after different durations of Ru^{III} reduction before adding ClO₃⁻. Reaction conditions: 1 mM C ClO₃⁻, 0.1 g L⁻¹ of 1 wt % Ru-1 wt % Pd/C or 1 wt % Ru/C, pH 7, 1 atm H₂, 20° C. XPS spectra (empty dots) and fits (solid lines) of Pd 3d and Ru 3p of (G+H) Ru—Pd/C and (I) Ru/C.

FIGS. 3A-3B show the ratio of dissolved Ru during the preparation of Ru/C (no Pd) with the all-in situ method: (A) adsorption followed by (B) H₂ sparging. Data in panel B started from the 4.9% Ru remained in solution after the 1 h adsorption shown in panel A. Reaction conditions: 0.1 g L⁻¹ carbon support, 1 mg L⁻¹ Ru from RuCl₃ (to prepare 1 wt % Ru/C), 1 atm H₂, 20° C.

FIG. 4 shows the catalytic reduction of 1 mM ClO₃⁻ by three 5 wt % Ru/C catalysts. The two catalysts prepared in the lab used the same carbon support. The 5 wt % content of Ru was chosen to compare with the commercially available 5 wt % Ru/C catalyst and thus validate the all-in situ method. Reaction conditions: 0.1 g L⁻¹ catalyst, pH 7, 1 atm H₂, 20° C.

FIGS. 5A-5D: (A) Profiles and TOF₀ for 1 mM ClO⁻ reduction by three catalysts prepared by the all-in situ method. (B) Chlorine balance during ClO₃⁻ reduction. (C) Reduction of 100 mM ClO₃⁻ by Ru—Pd/C and Ru/C. (D) pH dependence of Ru—Pd/C, Ru/C, and 5 wt % Rh/C and 5 wt % Mo-5 wt % Pd/C. First order rate constants were normalized by the loading of PGM. Reaction conditions 0.1 gL⁻¹ catalyst (1 wt % Ru and/or Pd), pH 7, 1 atm H₂, 20° C.

FIGS. 6A-6N: HAADF-STEM imaging of (A, B, G, and H) 1 wt % Ru-1 wt % Pd/C, (J) 1 wt % Pd/C, and (K) 1 wt % Ru/C prepared by the all-in situ method. (C, D, E, F and I) EDS elemental mapping. (L) EDS mapping of 1 wt % Pd-1 wt % Ru/C. The dotted areas in D, E, F and I highlight the Ru coverage outside Pd., Conceptual illustration of Ru and Pd particle formation in (M) Ru—Pd/C and (N) Ru/C.

FIG. 7 illustrates the catalytic reduction of 1 mM ClO₃⁻ by 1 wt % Ru-1 wt % Pd/C and 1 wt % Ru-1 wt % Rh/C. Reaction conditions: 0.1 g L⁻¹ catalyst, pH 7, 1 atm of H₂, and 20° C.

FIG. 8: Catalytic reduction of 1 mM ClO₃⁻ by Ru—Pd/C and Pd—Ru/C catalysts (both contain 1 wt % Pd and 1 wt % Ru). Reaction conditions: 0.1 g L⁻¹ catalyst, pH 7, 1 atm H₂, and 20° C. The filled data points (C/C₀>0.2) were used for the zeroth-order kinetic).

FIGS. 9A-9D: Profiles of (A) ClO⁻ reduction by individual Ru/C, Pd/C, and 1:1 mixed Ru/C+Pd/C at pH 7; (B) ClO₂⁻ reduction at pH 7.9 by Ru/Al₂O₃ and Pd/Al₂O₃; (C) ClO₂⁻ and ClO₃⁻ reduction in the mixture by Ru/Al₂O₃ at pH 7.9. Default reaction conditions: 0.1 g L⁻¹ of individual catalyst containing 1 wt % of metal, 1 mM ClO₃⁻ or ClO₂⁻, 1 atm H₂, 20° C. (D) Illustrated reaction mechanisms on the Ru—Pd/C catalyst surface.

FIGS. 10A-10D: Profiles of ClO₃⁻ reduction (A) in the presence of Cl⁻ and SO₄²⁻, (B) in tap water (pH 7.9) and DI water with and without 0.4 mM NO₃− (pH 8.0) at 0.5 gL−1 catalyst loading, (C) in the first and fifth ClO₃− spike (1 mM) in the same batch reactor, and (D) in the as prepared catalyst suspension and by the centrifuge-collected and redispersed catalyst. Default reaction conditions: 0.1 g L⁻¹ of wt % Ru-1 wt % Pd/C, 1 mM ClO₃⁻, pH 7, 1 atm H₂, 20° C.

FIG. 11: Catalytic reduction of 1 mM ClO₃⁻ by 1 wt % Ru-1 wt % Pd/C in the presence of 2 M NaCl. Reaction conditions: 0.1 g L⁻¹ catalyst, pH 7, 1 atm H₂, and 20° C. FIG. 10A shows the first 1 hour of the data set.

FIGS. 12A-12B: Catalytic reduction of (A) 0.4 mM NO₃⁻ and (B) 1 mM ClO₃⁻ by 1 wt % Ru-1 wt % Pd/C in the tap water and DI water. The first 15 minutes time windows are marked to highlight the slow NO₃⁻ reduction and relatively fast ClO₃⁻ reduction. Reaction conditions: 0.5 g L⁻¹ catalyst, pH 8, 1 atm H₂, and 20° C.

FIG. 13: Shows data from Example 5 for representative catalysts Ru—Pd/C, Ru—Rh/C, Ru—Pt/C, and Ru—Ir/C.

FIG. 14. Shows data from Example 6. NO3− Reduction Activity of M-Pd/C Catalysts Containing Group V-VIII Metals (M). See reaction conditions in Table 1.

FIG. 15. Shows data from Example 6. NO3− Reduction Activity of M-Ru/C Catalysts Containing Group V-VIII Metals (M). See reaction conditions in Table 2.

FIG. 16. Shows data from Example 6. NO3− Reduction Activity of Ru-M0/C Catalysts Containing Variable Hydrogenation Metal Nanoparticles (M0). See reaction conditions in Table 3.

FIG. 17. Shows data from Example 6. 1 mM ClO3− reduction by 0.1 g L−1 1 wt % Ru-1 wt % Pd/C and 0.2 g L−1 5 wt % Ru-5 wt % Ru/C. Reaction conditions: pH 3, 1 atm H2, 20° C.

FIG. 18. Shows data from Example 6. 1 mM NO₃⁻ reduction by Ru—Pd/C. Reaction conditions: pH 3, 1 atm H₂, 20° C.

FIG. 19. Shows data from Example 6. 1 mM NO3− reduction by 0.1 g L−1 Ru—Pd/C. Reaction conditions: pH 3, 1 atm H2, 20° C.

FIG. 20. Shows data from Example 6. Salt Effect on NO3− Reduction Activity with M-Pd/C Catalysts. Reaction conditions: catalyst (5 wt % Pd and 5 wt % M, 0.5 g L−1 for In and Re—Pd/C, 2 g L−1 for other catalysts); NaNO3 (1 mM); pH 3 (5 mM H3PO4/NaH₂PO4 buffer, adjusted by HCl in deionized water); H2 (1 atm); 25° C.

### DETAILED DESCRIPTION OF THE INVENTION

The solid support can be any material that is suitable for providing a catalyst that can be used to reduce ClO₃⁻ to Cl⁻. For example, in one embodiment, the solid support can comprise porous carbon, alumina, silica, a zeolite, a clay, TiO₂, CeO₂, ZrO₂, Mxene (Nanoscale Horiz., 2020, 5, 235-258), a carbon nanotube, graphene, or biochar. In one embodiment, the solid support comprises carbon. In one embodiment, the solid support is carbon.

In one embodiment, the catalyst comprises highly dispersed Ru⁰. The term highly dispersed Ru⁰ includes dispersions from a single atom to 20 nm. In one embodiment, the term includes dispersions from a single atom to about 5 nm. In one embodiment, the term includes dispersions from a single atom to about 3 nm. In one embodiment, the term includes dispersions from about 3 nm to about 5 nm.

As used herein, the term “turnover frequency” means the number of ClO₃⁻ that are reduced to Cl⁻:per minute:per Ru atom on the surface of the catalyst. In one embodiment, the turnover frequency of the catalyst is at least about 10. In one embodiment, the turnover frequency of the catalyst is at least about 11. In one embodiment, the turnover frequency of the catalyst is at least about 12. In one embodiment, the turnover frequency of the catalyst is at least about 13. In one embodiment, the turnover frequency of the catalyst is less than about 35. In one embodiment, the turnover frequency of the catalyst is less than about 30. In one embodiment, the turnover frequency of the catalyst is less than about 25. In one embodiment, the turnover frequency of the catalyst is in the range of from about 0.2 to about 30. In one embodiment, the turnover frequency of the catalyst is in the range of from about 5 to about 30. In one embodiment, the turnover frequency of the catalyst is in the range of from about 5 to about 20. In one embodiment, the turnover frequency of the catalyst is in the range of from about 5 to about 15. In one embodiment, the turnover frequency of the catalyst is in the range of from about 10 to about 15.

Specific values identified below are for illustration only; they do not exclude other defined values or other values within defined ranges. It is to be understood that two or more specific values may be combined. It is also to be understood that the specific values listed herein below (or subsets thereof) can be excluded from the invention.

Specifically, the water sample can also comprise ClO₂⁻ and/or ClO₄⁻.

Specifically, the method can be carried out at a pH in the range from about 3 to about 11.

Specifically, the method can be carried out at a pH in the range from about 3 to about 8.

Specifically, the method can be carried out at a pH in the range from about 5 to about 8.

Specifically, the method can be carried out at a pH of at least about 6.

Specifically, the method can be carried out at a pH of at least about 7.

Specifically, the sample can further comprise sulfate, phosphate, silicate, chloride, bromide, iodide, nitrate, nitrite, perchlorate, fluoride, or bromate.

Specifically, the sample can further comprise sulfate.

Specifically, the catalyst has a turnover number of at least 9,000 for ClO₃⁻.

Specifically, the catalyst has a turnover number of at least 10,000 for ClO₃⁻.

Specifically, the catalyst has a turnover number of at least 11,000 for ClO₃⁻.

Specifically, the catalyst has a turnover number of at least 15,000 for ClO₃⁻.

Specifically, the catalyst has a turnover number of at least 20,000 for ClO₃⁻.

Specifically, the Ru⁰ and the Pd⁰, Pt⁰, Rh⁰, or Ir⁰ together provide synergy.

Specifically, the reducing is carried out at a temperature in the range from about 4° C. to about 95° C.

Specifically, the reducing is carried out at a temperature in the range from about 10° C. to about 80° C.

Specifically, the reducing is carried out at a temperature in the range from about 10° C. to about 45° C.

Specifically, the reducing is carried out at a temperature in the range from about 15° C. to about 25° C.

Specifically, the reducing is carried out at a temperature of about 20° C.

Specifically, the reducing is carried out under 1-3 atm of H₂. In one embodiment, the reaction can be carried out in a mixture of an inert gas (e.g., N₂ or Ar) and H₂. In one embodiment, the ratio of inert gas to H₂ is about 90:10. In one embodiment, the ratio of inert gas to H₂ is about 80:20. In one embodiment, the ratio of inert gas to H₂ is about 70:30. In one embodiment, the ratio of inert gas to H₂ is about 60:40. In one embodiment, the ratio of inert gas to H₂ is about 50:50. In one embodiment, the ratio of inert gas to H₂ is about 40:60. In one embodiment, the ratio of inert gas to H₂ is about 30:70. In one embodiment, the ratio of inert gas to H₂ is about 20:80. In one embodiment, the ratio of inert gas to H₂ is about 10:90. In one embodiment, the ratio of inert gas to H₂ is about 5:95.

Specifically, the reducing is carried out under about 1 atm of H₂.

In one embodiment, the term “about” means ±20%.

The invention will now be illustrated by the following non-limiting Examples.

### EXAMPLES

### Example 1. Catalyst Preparation

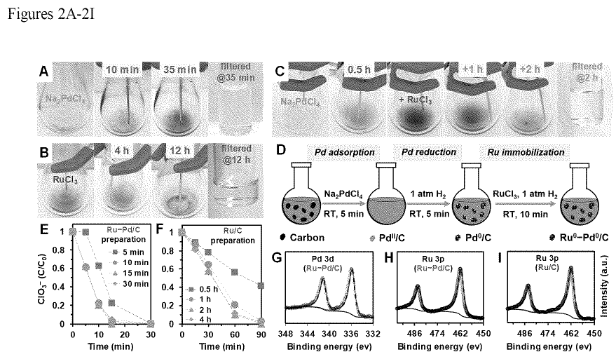

Both aqueous Ru^{III} (from RuCl₃·xH₂O) and Pd^{II} (from Na₂PdCl₄) can be reduced into Ru⁰ and Pd⁰ precipitates, respectively, by direct exposure to 1 atm H₂ in the headspace at 20° C., but the reduction of Ru^{III} is much slower than that of Pd^{II}. While the yellow Pd^{II} solution was fully converted into Pd black (i.e., large Pd⁰ solids) and colorless liquid within 35 min (FIG. 2A) (Gao, J. et al., ACS ES&T Eng. 1, 562-570 (2021), the same procedure could not complete the reduction of Ru^{III} by 12 h (FIG. 2B). However, Ru^{III} added to the Pd black suspension underwent fast color fading and particle formation within 2.5 h (FIG. 2C). Hence, Pd⁰ accelerated the H₂ reduction of Ru^{III} into Ru⁰. The adsorption behaviors of aqueous Ru^{III} and Pd^{II} on porous carbon support (1300 m² g⁻¹) were also different. While >98% of Pd^{II} was immobilized on carbon within 5 minutes, only 84% of Ru^{III} was immobilized in the same time frame.

A bimetallic catalyst was prepared by adding Ru^{III} into an all-in situ prepared Pd⁰/C (FIG. 2D). In the nanoscale carbon pores, the highly dispersed Pd⁰ particles were expected to provide a faster reduction of Ru^{III} than the bulky Pd black aggregates. The adsorption and reduction of Ru^{III} (onto Pd⁰/C by 1 atm H₂ at 20° C.) for only 10 minutes yielded the full activity of ClO₃⁻ reduction (FIG. 2E). The dissolved Pd and Ru in the aqueous phase were below 1 μg L⁻¹, showing that >99.9% of the two PGMs were immobilized. X-ray photoelectron spectroscopy (XPS) measured the binding energy (BE) of Pd 3d_{5/2} at 335.8 eV and Ru 3p_{3/2} at 461.8 eV (FIG. 2G and FIG. 2H), confirming the reduction of both metals to the metallic state. Therefore, only 20 minutes is needed to prepare Ru⁰—Pd⁰/C all-in situ from aqueous Ru^{III}, Pd^{II}, carbon support, and 1 atm H₂ at 20° C.

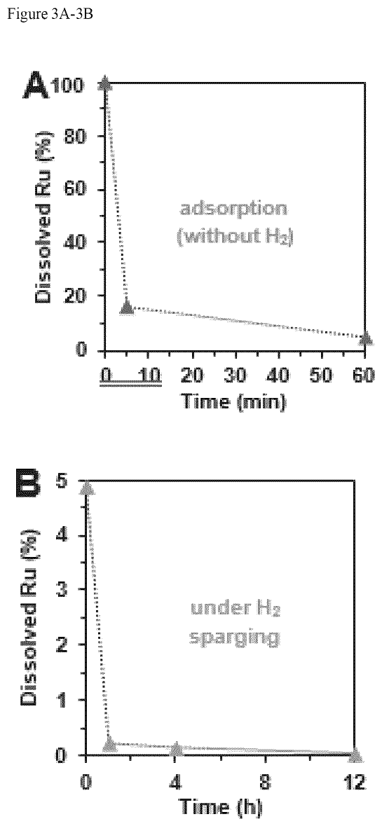

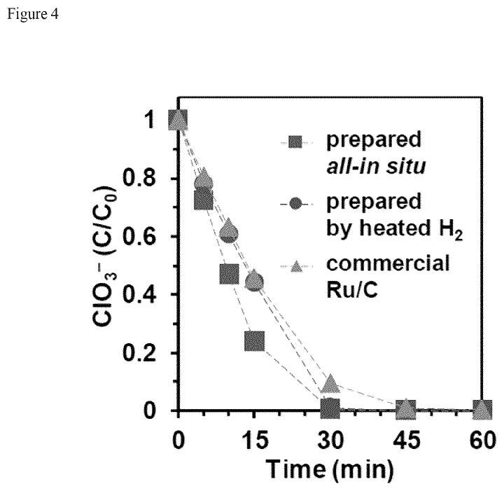

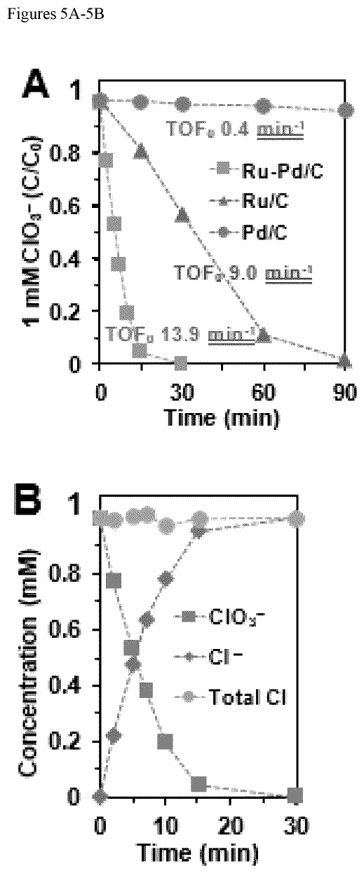

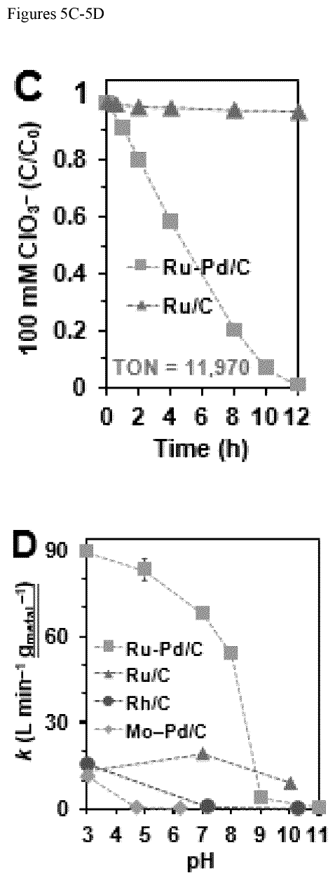

Ru^{III} was also directly immobilized on the same carbon support without Pd⁰. The adsorption of >95% Ru^{III} required 1 hour (FIG. 3A). Upon H₂ exposure for another 1 hour, the fraction of dissolved Ru was further lowered to 0.2% (FIG. 3B). XPS characterization confirmed the yield of Ru⁰/C (FIG. 2I, Ru 3p_{3/2} BE at 461.8 eV, the same as in Ru⁰—Pd⁰/C). More than 1 hour of H₂ exposure was required to maximize the ClO₃⁻ reduction activity (FIG. 2F). The three catalysts had consistent metal contents −0.64 wt % of Pd in Pd⁰/C, 0.68 wt % of Pd+0.98 wt % of Ru in Ru⁰—Pd⁰/C, and 0.94 wt % of Ru in Ru⁰/C. These values show the reliability of the all-in situ preparation method, which provides a fair basis for activity comparison. The all-in situ adsorption-reduction method for Ru was further validated by comparing it with the conventional incipient wetness+heated H₂ reduction method and a commercial catalyst (FIG. 4).

### Example 2. Chlorate Reduction Performance

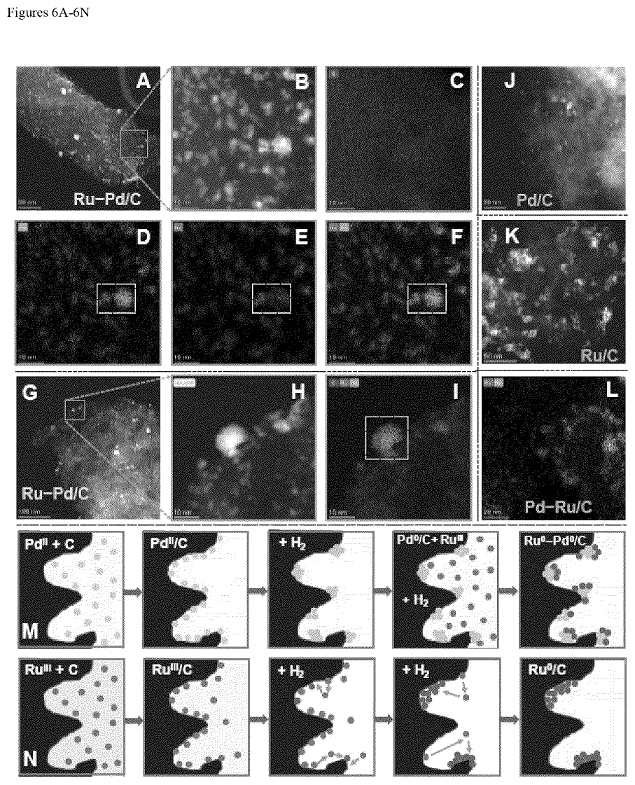

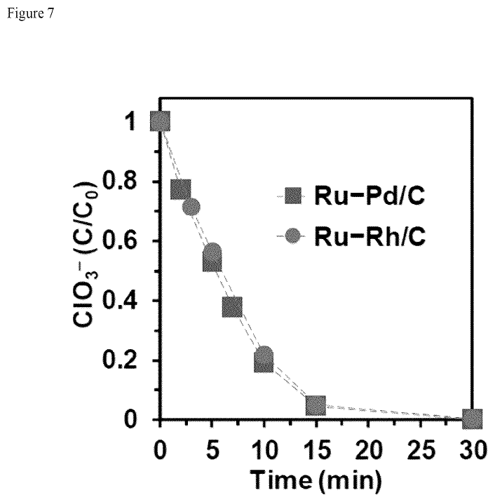

Based on the chemisorption data (Table 1) and ClO₃⁻ reduction time profile (FIG. 5A), the initial turnover frequency (TOF₀, the average number of ClO₃⁻ anions reduced by individual surface metal atoms upon the first sampling time) was calculated. At pH 7, Pd/C barely catalyzed ClO₃⁻ reduction (TOF₀=0.4 min⁻¹ on Pd⁰) while Ru/C was much more active (TOF₀=9.0 min⁻¹ on Ru⁰). Surprisingly, the Ru—Pd/C was substantially more active than Ru/C. A conservative estimation of TOF₀ (see later sections for the estimation of Ru dispersion) is 13.9 min⁻¹ on Ru⁰. A good mass balance of Cl was established between ClO₃⁻ and Cl⁻ (FIG. 5B), indicating no accumulation of other chlorine species.

TABLE 1
Metal Dispersion from CO Chemisorption.ª

| | | Metal |
|---|---|---|
| Entry | Catalyst | dispersion |
| 1 | Pd/C | 20.9% |
| 2 | Ru/C | 15.0% |
| 3 | Ru/C^{b} | 37.1% |
| 4 | Ru—Pd/C | 36.5-42.5%^{c} |
| 5 | Pd—Ru/C | 25.0-29.2%^{c} |

^{a}Unless specified, the catalysts were prepared by the all-in situ method with a nominal 1 wt % content for each metal. The stoichiometries for Ru:CO and Pd:CO are 12:7⁴⁰ and 2:1,⁴¹ respectively.
^{b}Prepared by conventional method involving incipient wetness impregnation and reduction with heated H₂ (see Method section for details).
^{c}The lower and higher limits were calculated assuming all-Ru and all-Pd scenarios in the bimetallic system.

Ru and Pd contents from 0.1 to 5 wt % were extensively screened to identify the roles of both metals. First, the addition of Ru as low as 0.1 wt % can significantly enhance the activity of monometallic Pd/C (Table 2, entry 4 versus entry 5) and vice versa (entry 6 versus entry 7), suggesting the synergy between Ru and Pd. The highest activity was shown when the two metals were both at 1 wt %. An unexpected advantage of Ru—Pd/C over Ru/C was observed from the treatment of concentrated ClO₃⁻.

The use of 0.1 g/L Ru—Pd/C achieved 99.9% reduction of 100 mM ClO₃⁻ (FIG. 2C) with a turnover number (TON, the total number of ClO₃⁻ anions reduced by each surface Ru atom) of 11,970. In contrast, Ru/C was substantially inhibited by the concentrated ClO₃⁻ (FIG. 2C versus A). Second, increasing the metal contents above 1 wt % did not proportionally accelerate ClO₃⁻ reduction (Table 2, entries 1-3). Instead, the rate constant normalized by the total mass of Ru and Pd became lower, probably due to the decreased metal dispersion. Third, decreasing the metal content below 1 wt % did not further increase the normalized rate (Table 2, entries 3, 8, and 9). In other words, in order to support the same amount of metal to achieve the same reaction rate, more carbon material needs to be used. Thus, a 1 wt % formulation was used for both Ru and Pd.

TABLE 2
Rate Constants of ClO₃⁻ Reduction by RU—Pd/C
Catalysts with Variable Formulations.

| | | | Apparent | Metal-normalized |
|---|---|---|---|---|
| | | | rate | rate |
| | Pd | Ru | (mM | (mmol gₘₑₜₐₗ⁻¹ |
| Entry | (wt %) | (wt %) | min⁻¹)^{a} | min⁻¹)^{b} |
| 1 | 5 | 5 | 0.116 | 11.6 |
| 2 | 3 | 3 | 0.114 | 19.1 |
| 3 | 1 | 1 | 0.091 | 45.3 |
| 4 | 1 | 0.1 | 0.010 | 9.2 |
| 5 | 1 | 0 | 0.001 | 0.8 |
| 6 | 0.1 | 1 | 0.024 | 21.5 |
| 7 | 0 | 1 | 0.014 | 14.3 |
| 8 | 0.5 | 0.5 | 0.040 | 40.1 |
| 9 | 0.1 | 0.1 | 0.009 | 44.0 |

^{a}Reaction conditions: 0.1 g L⁻¹ of Ru—Pd/C, 1 mM ClO₃⁻ , pH 7, 1 atm H₂, 20° C.
^{b}Normalized to the total mass of Ru and Pd.

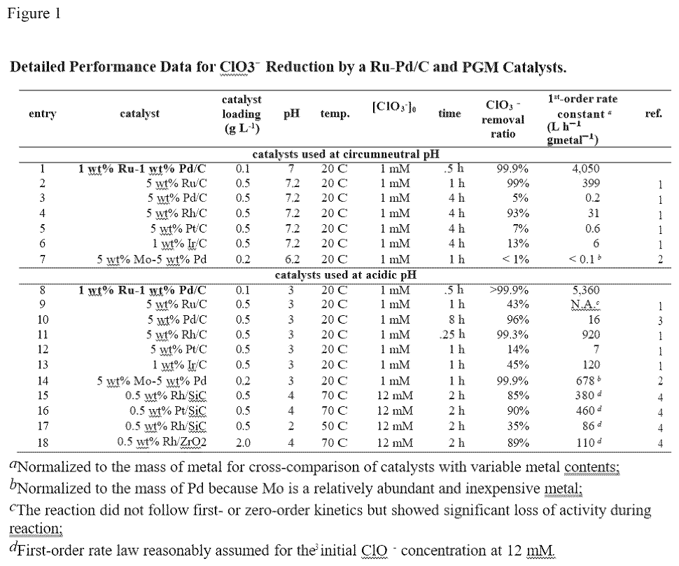

The Ru—Pd/C outperforms all reported PGM-based catalysts for ClO₃⁻ reduction in a wide pH range from 3 to 8. At pH 7, the metal-normalized first-order rate constant is more than two orders of magnitude higher than those of Rh/C (Chen, X. et al. Chem. Eng. J. 313, 745-752 (2017)) and Mo—Pd/C (Ren, C. et al., ACS Catal. 10, 8201-8211 (2020)) (FIG. 5D), both of which show the highest activity at pH 3. However, the activity of Ru—Pd/C also increased at pH 3, still being 5-7 times more active than Rh/C and Mo—Pd/C under the acidic condition. A comprehensive comparison of all PGM catalysts is provided in FIG. 1. Although Rh/C is much more active than Pd/C for ClO₃⁻ reduction at pH 7 (FIG. 1, entry 4 versus 3), the Ru—Rh/C catalyst prepared by the same all-in situ method showed almost identical activity as Ru—Pd/C (FIG. 7), corroborating the dominant role of Ru in the reaction with ClO₃⁻. Thus, the use of Ru avoids the use of Rh and saves a substantial amount of Pd. Rh is 28 times more expensive than Ru (platinum.matthey.com), while Pd is 3 times more expensive but 3-4 orders of magnitude less active than Ru. However, in comparison to the monometallic Ru/C, the significantly enhanced activity, robustness with concentrated ClO₃⁻, and different pH dependence of Ru—Pd/C also suggest important roles of Pd in catalyst structure and reaction scheme.

### Example 3. Mechanistic Elucidation

High-angle annular dark-field scanning transmission electron microscopy (HAADF-STEM) characterization of Ru—Pd/C observed fine metal particles with an average size of 2.3 nm on the carbon support (FIGS. 6A, 6B, 6G, and 6H). The size is apparently larger than Pd particles of Pd/C (<2 nm on average; Gao, J. et al., ACS ES&T Eng. 1, 562-570 (2021)) before accommodating Ru (FIG. 6J versus 6A). Energy-dispersive X-ray spectroscopy (EDS) elemental mapping (FIGS. 6C-6F) confirmed the bright spots as overlapped Pd and Ru. The relatively large particles clearly show the mixing pattern as a layer of Ru on the outside of Pd particles (FIGS. 6F and 6I). Hence, Ru^{III} was rapidly reduced as Ru⁰ on Pd⁰ particles by the on-surface active H (FIG. 6M; Conrad, H., Ertl, G. & Latta, E., Surf Sci. 41, 435-446 (1974)). Besides, one cannot exclude the scenario that a minor fraction of Ru was reductively immobilized in the vicinity of Pd⁰ particles by spilled-over H on the carbon support (Prins, R. Chem. Rev. 112, 2714-2738 (2012)).

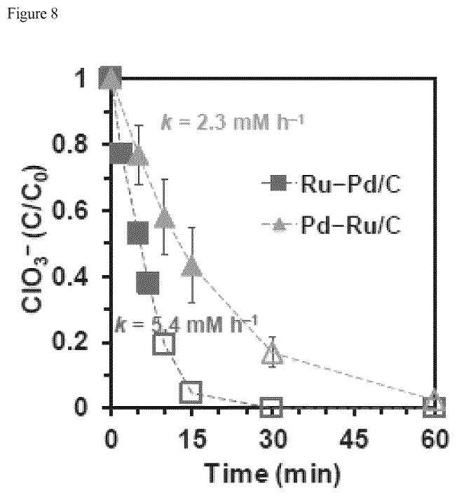

In stark contrast, the direct reduction of Ru^{III} on carbon resulted in large aggregates (FIG. 6K). In comparison to Pd^{II}, the poorer adsorption of Ru^{III} and much slower reduction (by H₂ at 20° C.) could be responsible for such morphology (FIG. 6N). Relatively few Ru⁰ seeds could form at the beginning, and the remaining Ru^{III} could migrate to the surface or vicinity of existing Ru⁰ particles, slowly react with the active H, and gradually yield the bulky Ru⁰ solid. The integration of Pd⁰ with Ru⁰/C was also achieved. Elemental mapping of Pd—Ru/C found the overlapping of Pd and Ru in much larger aggregates than in Ru—Pd/C (FIG. 6L versus 6F, note the scale). Not surprisingly, the ClO₃⁻ reduction activity of Pd—Ru/C was only 43% of that of Ru—Pd/C (FIG. 8).

Chemisorption data indicate substantially enhanced metal dispersion in the bimetallic catalysts (FIG. 1). While the Pd dispersion in Pd/C was 20.9%, the total metal dispersion in Ru—Pd/C ranged from 36.5% (all Ru) to 42.5% (all Pd), based on the stoichiometry for Ru:CO (12:7) and Pd:CO (2:1). Without a high-temperature process, the later added Ru is less likely to change the morphology of Pd. Thus, the enhanced dispersion in Ru—Pd/C should be attributed to high dispersion of Ru ranging from 55% (if Pd and Ru did not overlap at all) to 85% (if Pd was completely covered by Ru). This value is higher than Ru/C prepared by the conventional method (37.1%), which accelerated metal reduction by heated H₂. Similarly, the total metal dispersion in Pd—Ru/C (25.0-29.2%) is also higher than Ru/C (15.0%). In comparison to Pd/C (20.9% dispersion), Ru enhanced the Pd dispersion in Pd—Ru/C to the calculated 35-58%.

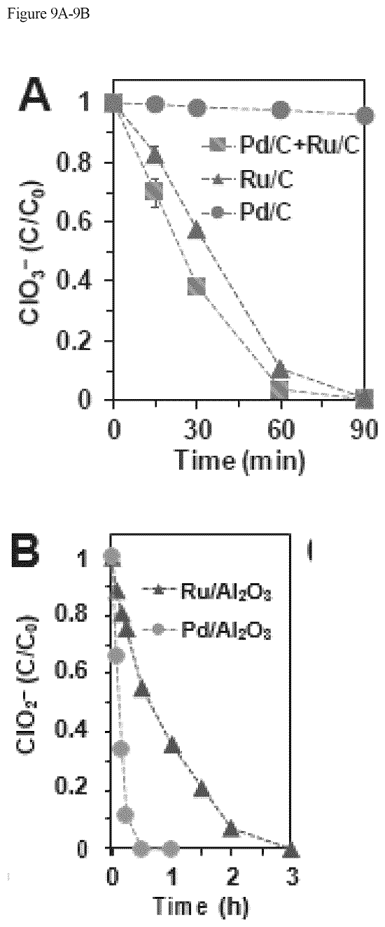

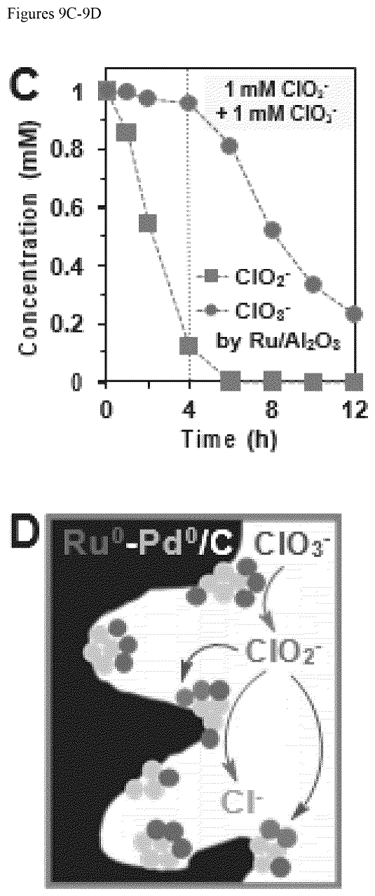

The >55% dispersion of Ru in Ru—Pd/C could contribute to the higher ClO₃⁻ reduction activity than Pd—Ru/C (dispersion of Ru<15% due to Pd coverage). However, the higher activity of Pd—Ru/C (k=2.3 mM h⁻¹) than Ru/C (k=0.9 mM h⁻¹) suggests other critical roles of Pd. Despite the negligible activity of Pd/C at pH 7, a 1:1 mixture of the two monometallic Pd/C and Ru/C catalysts exhibited a higher activity than using Ru/C only (FIG. 9A). Thus, the individual activity of Ru and Pd with ClO₂⁻ was investigated, since ClO₂⁻ is the most probable first intermediate from ClO⁻ reduction. Since ClO₂⁻ can react with carbon (Voudrias, E. et al. Water Res. 17, 1107-1114 (1983); and Gonce, N. & Voudrias, E. A., Water Res. 28, 1059-1069 (1994), Pd/Al₂O₃ and Ru/Al₂O₃ were prepared with the same all-in situ method (Gao, J. et al., ACS ES&T Eng. 1, 562-570 (2021)). Pd/Al₂O₃ showed 5.4-fold higher activity of ClO⁻ reduction than Ru/Al₂O₃ (FIG. 9B). More interestingly, when 1:1 of ClO₃⁻ and ClO₂⁻ were added together to Ru/Al₂O₃, the reduction of ClO⁻ was largely inhibited until >90% of ClO⁻ was reduced first (FIG. 9C). Therefore, the loss of activity of Ru/C upon treating 100 mM ClO₃⁻ (FIG. 5C) is likely attributed to the accumulation of ClO⁻ shortly after the reaction. Reactions of Ru species with ClO⁻ (and the potential daughter product ClO⁻) are complex. For example, bulk Ru⁰ can be oxidized by concentrated ClO⁻ toward dissolution (Howe, J. L. & Mercer, F. N., J. Am. Chem. Soc. 47, 2926-2932 (1925)); oxidized Ru species such as Ru^{II} and H⁺ can trigger complex decomposition of ClO⁻ into ClO, HOCl, ClO⁻, and Cl⁻Hu, Z. et al., ChemComm 48, 475, 1102-1104 (2012); and Deshwal, B. R., et al., Can. J. Chem. Eng. 82, 619-623 (2004)). Details of these reactions remain largely unexplored. Nevertheless, the findings above clearly suggest the synergy between Ru⁰ and Pd⁰; Ru reduces ClO₃⁻ for a fast overall reaction while Pd rapidly scavenges ClO⁻ and generates active H to minimize the oxidative deactivation of Ru (FIG. 9D). The oxidized Ru can still be reduced back to Ru⁰ by Pd-activated H₂ (FIGS. 2B and 6N).

### Example 4. Catalyst Robustness

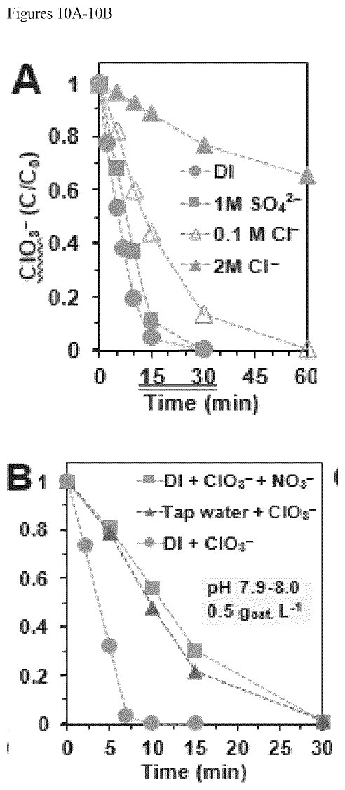

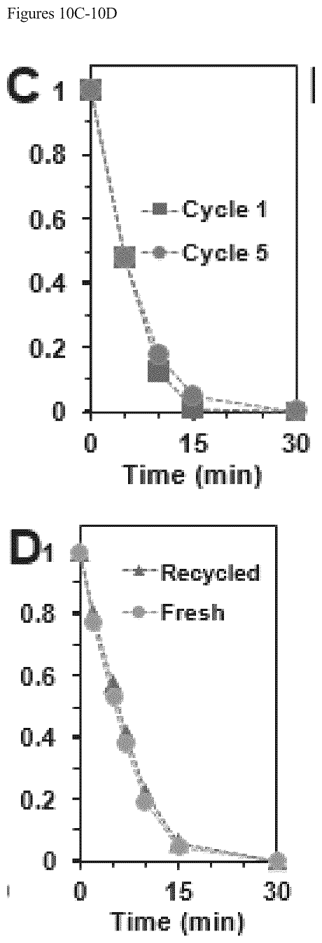

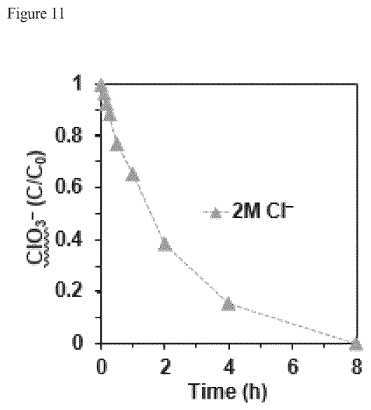

The performance of Ru—Pd/C for ClO₃⁻ reduction was assessed in typical application scenarios, such as (i) chloralkali NaCl brines containing the undesirable ClO₃⁻ byproduct from the anode (Van Santen, R., et al., U.S. Pat. No. 6,270,682 (2001)), (ii) waste stream from reverse osmosis or ion-exchange that enriched ClO₃⁻ from source water, and (iii) drinking water containing ClO₃⁻ from source water or disinfection operations (Gorzalski, A. S. & Spiesman, A. L. J. Am. Water Works Assoc. 107, E613-E626 (2015). Because modern water treatment usually involves sequential processes and does not expose advanced systems to raw water or known poisoning/destructive species (Ren, C., e t al , ACS ES&T Eng. 2, 181-188 (2022); and Anis, S. F., et al., Water Res. 452, 159-195 (2019)), the catalyst was not challenged with sulfide (a potent PGM catalyst poison but readily oxidizable, Tomar, M. & Abdullah, T. H., Water Res. 28, 2545-2552 (1994)) or humic acid (a common fouling species but readily adsorbable, Chaplin, B. P. et al., Environ. Sci. Technol. 46, 3655-3670 (2012)). Instead, anions such as Cl⁻ and SO₄²⁻ are ubiquitous co-existing species. The presence of 1.0 M SO₄²⁻, 0.1 M Cl⁻, and 2.0 M Cl⁻ decreased the rate of 1 mM ClO₃⁻ reduction for 30%, 58%, and 94%, respectively (FIG. 10A). Even under the inhibition by 2.0 M Cl⁻, the reduction of 1 mM ClO₃⁻ was completed within 8 hours (FIG. 11). Thus, a higher loading of catalyst can be used to proportionally boost the apparent reaction rate (Ren, C., et al., ACS ES&T Eng., 2, 181-188 (2022); and Ren, C. et al., J. Am. Chem. Soc. 143, 7891-7896 (2021)).

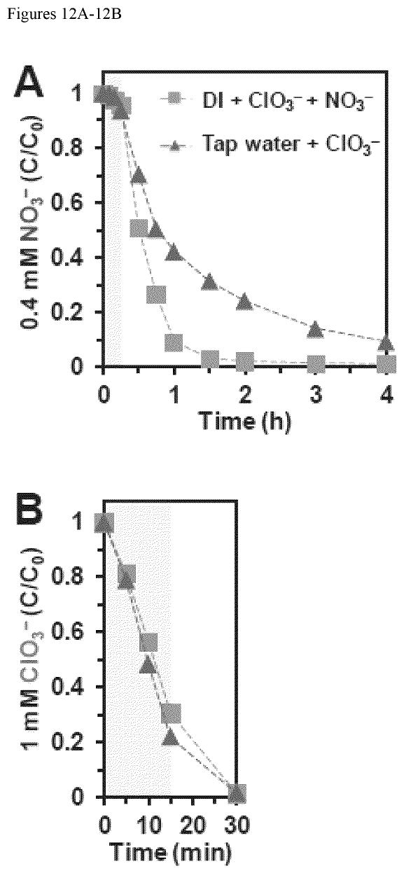

Ru—Pd/C was also tested in a tap water sample from Southern California, where the groundwater occasionally contained ClO₃⁻ slightly higher than the minimum reporting level (0.02 mg L⁻¹, or 0.24 μM). The tap water had an initial pH of 7.9 and contained 0.4 mM of NO₃⁻. The use of 0.5 g L⁻¹ Ru—Pd/C reduced the spiked 1 mM ClO₃⁻ for 99, 99.95, and >99.99% (i.e., lower than the detection limit of 0.1 μM) within 30, 45, and 60 minutes, respectively (FIG. 10B). However, the reaction rate was slower than in the deionized (DI) water. The addition of 0.4 mM NO₃⁻ in DI water resulted in a very similar level of inhibition as in the tap water. Therefore, other constituents in the tap water were not significant inhibitors of Ru—Pd/C. This catalyst showed a relatively low activity for NO₃⁻ reduction at pH 8, and NO₃⁻ reduction barely proceeded before the majority of ClO₃⁻ was reduced (FIG. 12).

Preliminary reuse tests show that Ru—Pd/C did not lose activity after five spikes of 1 mM ClO⁻ (FIG. 10C), because the inhibition by Cl⁻ in the mM concentration range is negligible. Centrifugation and handling in air did not deactivate the recycled catalyst (FIG. 10D). The PGM leaching into water was below the detection limit (10 μg L⁻¹; i.e., <1% of the immobilized 1 wt % Ru or Pd) from these operations

### Methods

Chemicals and Materials. RuCl₃·xH₂O (99.98%), Na₂PdCl₄ (≥99.99%), NaClO₃ (≥99%), and NaClO₂ (technical grade, 80%) were used as received from Sigma-Aldrich. The activated carbon support (Norit GSX, steam activated and acid-washed, surface area 1300 m² g⁻¹) from Alfa Aesar (#L11860). The alumina support was received as ⅛″ pellets from Alfa Aesar (#43855) and ground into powders before use. A commercial 5 wt % Ru/C was used as received from Alfa Aesar (#44338). Except for the tap water, all aqueous solutions were prepared with Milli-Q water (resistivity >18.2 MΩ cm).

Catalyst Preparation. All-in situ Method for Pd/C and Ru—Pd/C: A 50 mL flask was sequentially loaded with a magnetic stir bar, 5 mg of carbon powder, 50 mL of DI water, and Na₂PdCl₄ stock solution. The mixture was sonicated for 1 min to disperse the carbon particles and stirred at 350 rpm for 4 minutes to allow the adsorption of Pd^{II}. The flask was capped by a rubber stopper. A 16-gauge needle penetrating the stopper was connected to the H₂ gas supply (2-3 mL min⁻¹), and the needle tip was pushed under water. The other needle had the tip above the water as the gas outlet to the atmosphere. After 5 minutes of H₂ sparging at 20° C., all adsorbed Pd^{II} was reduced to Pd⁰. The Pd⁰/C suspension was added with RuCl₃ stock solution and sparged with H₂ for another 10 minutes at 20° C. to reduce adsorbed Ru^{III} to Ru⁰, yielding Ru⁰—Pd⁰/C.

All-in situ Method for Ru/C and Pd—Ru/C. The preparation followed the same procedure as detailed above. However, the direct immobilization of Ru^{III} onto carbon took 1 hour, and the subsequent reduction by H₂ took 4 hours to yield Ru⁰/C. The immobilization of Pd⁰ onto the resulted Ru⁰/C still took 5 minutes for Pd^{II} adsorption and 5 minutes for the reduction by H₂, yielding Pd⁰—Ru⁰/C.

Conventional Method for Ru/C. The Ru^{III} precursor was impregnated into the same carbon support material by incipient wetness. The wet paste was dried in an oven at 75° C. for 12 hours and reduced with 90/10 (v/v) N₂/H₂ at 450° C. for 6 hours to yield Ru⁰/C (Lin, B. et al. ACS Catal. 9, 1635-1644 (2019); and Lin, B., et al., ChemCatChem 5, 1941-1947 (2013)).

Catalyst Characterization. The solid catalyst was collected from the water suspension by filtration under vacuum. The filter paper with the black paste was dried at 20° C. by the airflow in a fume hood. No inert gas protection was involved for catalyst handling or transportation. The Ru and Pd content in the catalysts were measured by inductively coupled plasma-optical emission spectrometry (ICP-OES, PerkinElmer Optima 8300) after digestion at the Microanalysis Laboratory, University of Illinois at Urbana-Champaign. The oxidation state of Ru and Pd was characterized by X-ray photoelectron spectroscopy (XPS, Kratos AXIS Supra). The sp² C 1 s peak (284.5 eV) of the carbon support was used for binding energy (BE) calibration. XPS spectra in the resolution of 0.1 eV were fitted using CasaXPS (version 2.3.19). Microscopic characterization was conducted using the scanning transmission electron microscopy (STEM, FEI Titan Themis 300) equipped with an energy dispersive X-ray spectrometer (EDS) system. The catalyst powder was resuspended and sonicated in distilled water to further reduce the size. The STEM images were acquired with a high-angle annular dark-field (HAADF) detector. Nano Measurer software package was used for the statistical analysis of average particle size in the STEM images. The specific surface areas of Ru and Pd were determined by CO pulse titration experiments on a Quantachrome Autosorb-iQ physisorption-chemisorption instrument. The calculation of metal dispersion used the surface Ru:CO and Pd:CO stoichiometry of 12:7 (Chen, Q. et al. J. Phys. Chem. C 119, 8626-8633 (2015)) and 2:1 (Hooshmand, Z., Le, D. & Rahman, T. S. Surf Sci. 655, 7-11 (2017)), respectively.

Chlorate and Chlorite Reduction. During the all-in situ catalyst preparation, the solution pH was significantly lowered from pH 6.5 (DI water with dissolved CO₂) because of the hydrolysis and reduction of [Pd^{II}Cl₄]²⁻ and Ru^{III}Cl₃ (Gao, J. et al., ACS ES&T Eng. 1, 562-570 (2021); and Lebedeva, A. et al., Inorg. Chem. 58, 4141-4151 (2019)). Therefore, the solution pH was adjusted by NaOH to pH 7.0 before adding ClO₃⁻ or ClO₂⁻. The addition of 1 mM NaClO₂ stock solution increased the pH from 7.0 to 7.9 due to the hypochlorite impurity. However, as ClO₂⁻ is sensitive to acidic conditions (Deshwal, B. R., et al., Can. J. Chem. Eng. 82, 619-623 (2004)), the pH was not adjusted back to 7.0 after the addition. The catalytic reduction of ClO₃⁻ and ClO₂⁻ started upon their spike into the catalyst suspension. The flow of 1 atm H₂ was maintained at 2-3 mL min⁻¹, and the flask reactor was placed on the benchtop (20° C.). Aliquots were collected through the H₂ outlet needle with a 3 mL plastic syringe and immediately filtered through a 0.22-μm cellulose acetate membrane.

The experiment in tap water (containing 0.4 mM NO₃⁻) used a 50 mL double-neck flask. Both necks were capped with rubber stoppers. One stopper accommodated two needles as the H₂ inlet and outlet/sampling port, respectively. The other stopper accommodated a Fisherbrand accumet gel-filled pencil-thin pH combination electrode to monitor the pH during the reaction. While the reduction of ClO₃⁻ and ClO₂⁻ do not consume H⁺, the reduction of NO₃⁻ consumes H⁺ and may elevate the pH Liu, J., et al., Water Res. 47, 91-101 (2013)). To maintain the solution pH at 7-8, H₂SO₄ (0.1 M) was added via the sampling needle when the pH reading went higher than 8.0.

Sample Analysis and Kinetic Evaluation. The concentrations of ClO₃⁻ and ClO₂⁻ were determined by ion chromatography (Dionex ICS-5000) equipped with a conductivity detector and an IonPac AS19 column. The column temperature was set at 30° C., with 20 mM KOH eluent at 1 mL min₋₁. The concentrations of Ru and Pd in aqueous samples were analyzed by ICP-OES (detection limit 10 μg L⁻¹).

When all ClO₃⁻ was reduced, the turnover number (TON) was calculated as

TON=[ClO₃⁻]₀×M_{w}/(L_{cat.}×Cₘₑₜₐₗ×Dₘₑₜₐₗ)

where [ClO₃⁻]₀ is the initial concentration of chlorate (mol L⁻¹), M_{w} is the atomic mass of Ru or Pd (g mol⁻¹), L_{cat.} is the loading of catalyst powder (g L⁻¹), Cₘₑₜₐₗ is the metal content, and Dₘₑₜₐₗ is the metal dispersion.

The initial turnover frequency (TOF₀), in min₋₁) was calculated as

TOF₀=([ClO₃⁻]₀−[ClO₃⁻]ₜ)×M_{w}/(L_{cat.}×Cₘₑₜₐₗ×Dₘₑₜₐₗ×t)

where [ClO₃⁻]ₜ is the concentration at the first sampling point of reaction time t (min).

### Conclusions

A highly active Ru—Pd/C catalyst was conveniently prepared by sequential all-in situ adsorption-reduction of Pd^{II} and Ru^{III} precursors on the carbon support. The preparation only takes 20 minutes using 1 atm H₂ at 20° C. without heating procedures. The Pd⁰ nanoparticles enhance the reduction of Ru^{III} into highly dispersed (>55%) Ru⁰. The resulting Ru—Pd/C catalyst shows a substantially higher activity of ClO₃⁻ reduction into Cl⁻ than any reported catalyst at both neutral and acidic pH. The catalyst allows complete reduction of ClO₃⁻ in the presence of concentrated SO₄²⁻ and as well as in the tap water matrix. While Ru shows high reactivity with ClO₃⁻, Pd is more reactive with ClO₂⁻, an inhibitor of Ru. The synergy between Ru and Pd makes Ru—Pd/C superior to monometallic Ru/C, especially in reducing concentrated ClO₃⁻.

### Example 5. Additional Catalysts

Additional catalysts were prepared and tested as follows.

### Reaction Conditions

Catalyst including 1 wt % Ru added in 1 wt % M/C (M=Pd, Rh, Pt, and Ir). Pd/C, Rh/C, and Pt/C were prepared as described by Gao, J. et al., ACS ES&T Eng. 1, 562-570 (2021); Ir/C was purchased from Alfa-Aesar. For all catalysts, the Ru metal was immobilized in situ as described herein above. The catalyst loading was 0.1 g/L of the powder material in water at pH 7 and 20° C. The initial concentration of chlorate was 1 mM.

### Conclusion

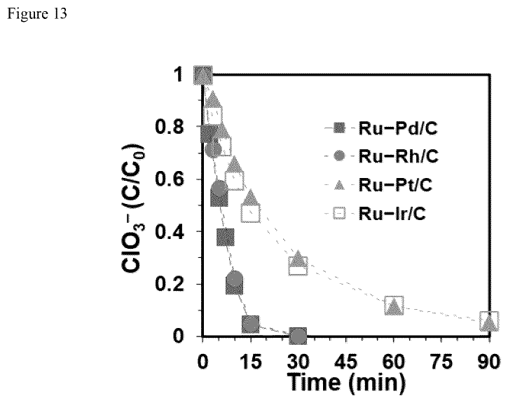

The catalysts were found to be highly effective for chlorate reduction at pH 7. Data for representative catalysts of the invention is provided in FIG. 13.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

### Example 6. Nitrate Reduction

Catalysts were prepared using the same procedure as described above for Ru—Pd/C, with the exception of using different metal salts.

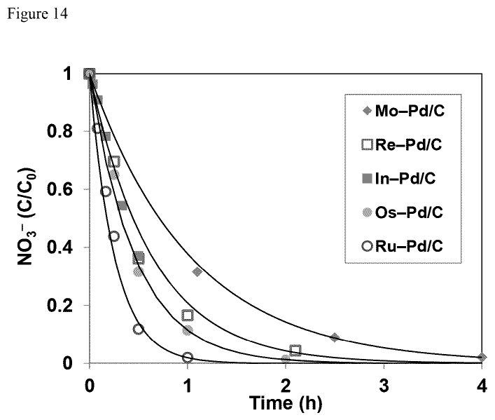

M-Pd/C Catalysts Containing Group 5-8 Metals (M). Bare Pd/C exhibited no activity in NO₃⁻ reduction (Table 3 and FIG. 14). The incorporation of Group 5-8 metals enabled the reaction. Notably, among the catalysts, Ru—Pd/C showed the activity.

TABLE 3
NO₃⁻ Reduction Activity of M—Pd/C Catalysts
Containing Group V-VIII Metals (M)ª

| | NO₃⁻ reduction | k |
|---|---|---|
| Catalyst | after 1 h | (L h⁻¹ g_{cat}⁻¹) |
| Pd/C | No reaction | |
| V—Pd/C | 3.9% | NA^{c} |
| Mo—Pd/C | 68.4% | 0.481 ± 0.021 |
| W—Pd/C | No reaction | NA^{c} |
| Re—Pd/C | 83.4% | 0.744 ± 0.056 |
| Os—Pd/C | 92.6% | 1.32 ± 0.06 |
| Ru—Pd/C | >99.9% | 8.66 ± 0.65^{d} |
| In—Pd/C^{b} | >99.9% | 2.97 ± 0.23^{d} |

^{a}Reaction conditions: catalyst (5 wt % Pd and 5 wt % M, 2 g L⁻¹); NaNO₃ (1 mM); pH 3 (5 mM H₃PO₄/NaH₂PO₄ buffer, adjusted by HCl in deionized water); H₂ (1 atm); 25° C.
^{b}Prepared with impregnation and calcination of In(NO₃)₃ in Pd/C.
^{c}No further kinetic measurement conducted due to the low reactivity shownin the 1-h screening.
^{d}Kinetics measured with a reduced catalyst loading of 0.5 g L⁻¹.

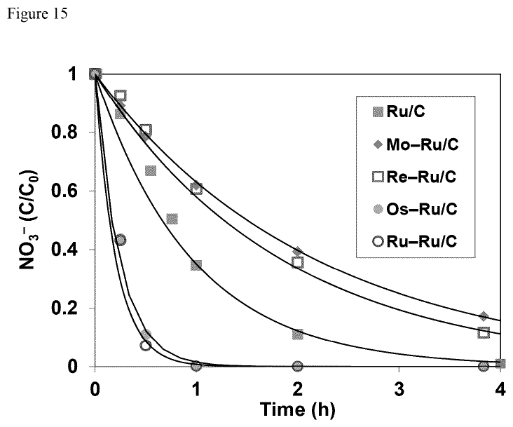

M-Ru/C Catalysts Containing Group 5-8 Metals (M). Bare Ru/C effectively catalyzed nitrate reduction at a moderate rate (Table 4 and FIG. 15). Incorporating Group 8 (Ru and Os) metals enhanced the reaction rate, whereas the introduction of Group 6 (Mo) and 7 (Re) metals decelerated the reaction.

TABLE 4
NO₃⁻ Reduction Activity of M—Ru/C Catalysts
Containing Group V-VIII Metals (M)ª

| | NO₃⁻ reduction | k |
|---|---|---|
| Catalyst | after 1 h | (L h⁻¹ gcat⁻¹ ) |
| Ru/C | 65.4% | 2.29 ± 0.11 |
| Re—Ru/C | 39.3% | 1.13 ± 0.03 |
| Mo—Ru/C | 38.1% | 0.917 ± 0.006 |
| Os—Ru/C | 99.8% | 8.81 ± 1.26 |
| Ru—Ru/C | 99.8% | 10.5 ± 2.2 |

^{a}Reaction conditions: catalyst (5 wt % Pd and 5 wt % M, 0.5 g L⁻¹); NaNO₃ (1 mM); pH 3 (5 mM H₃PO₄/NaH₂PO₄ buffer, adjusted by HCl in deionized water); H₂ (1 atm); 25° C.

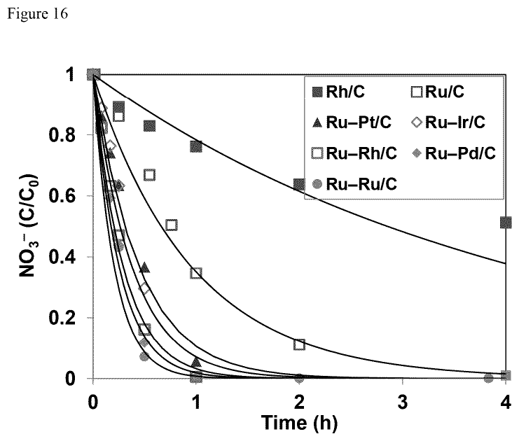

Ru-M⁰/C Catalysts Containing Variable Hydrogenation Metal Nanoparticles)(M⁰). Among the five hydrogenation metals (Ru, Rh, Pd, Ir and Pt), only Ru and Rh exhibited NO₃⁻ reduction activity (Table 5 and FIG. 16). Introducing Ru to all these metals substantially enhanced the reaction rate, with Ru—Ru/C displaying the highest activity.

TABLE 5
NO₃⁻ Reduction Activity of Ru—M⁰/C
Catalysts Containing Variable
Hydrogenation Metal Nanoparticles (M⁰)^{a}

| | NO₃⁻ reduction | k |
|---|---|---|
| Catalyst | after 1 h | (L h⁻¹ g_{cat}⁻¹) |
| Ru/C | 65.4% | 2.29 ± 0.11 |
| Ru—Ru/C | 99.8% | 10.5 ± 2.2 |
| Rh/C | 23.8% | 0.426 ± 0.046 |
| Ru—Rh/C | 99.5% | 7.42 ± 0.46 |
| Ir/C^{b} | No reaction | |
| Ru—Ir/C^{b} | 98.4% | 4.97 ± 0.44 |
| Pt/C | No reaction | |
| Ru—Pt/C | 94.4% | 5.76 ± 0.46 |
| Pd/C | No reaction | |
| Ru—Pd/C | 98.0% | 8.66 ± 0.65 |

^{a}Reaction conditions: catalyst (5 wt % M⁰ and 5 wt % Ru, 0.5 g L⁻¹); NaNO₃ (1 mM); pH 3 (5 mM H₃PO₄/NaH₂PO₄ buffer, adjusted by HCl in deionized water); H₂ (1 atm); 25° C.
^{b}1 wt % Ir⁰ in catalyst.

### Optimization of the Ru—Pd/C Catalyst.

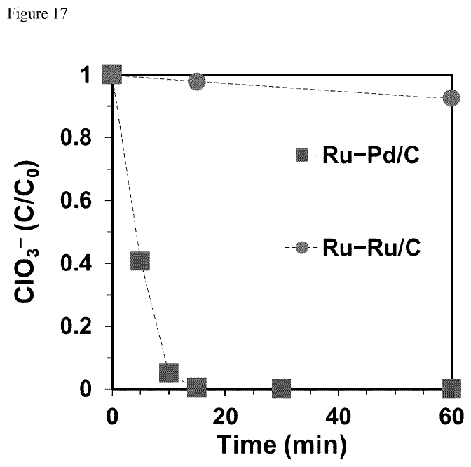

Among the screened catalysts, Ru—Ru/C and Ru—Pd/C exhibited the highest activity in NO₃⁻ reduction (Table 3-5). However, Ru—Ru/C showed limited activity in ClO₃⁻ reduction (FIG. 17).

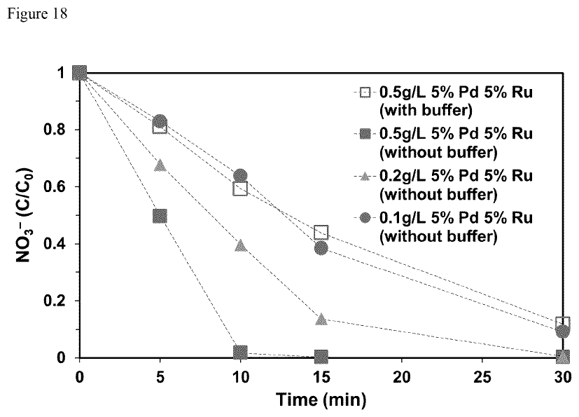

The NO₃⁻ reduction with Ru—Pd/C catalyst is even faster without phosphate buffer (FIG. 18). Using 0.1 g L⁻¹ of catalyst without buffer yields a reaction rate equivalent to that achieved by using 0.5 g L⁻¹ of catalyst with buffer (FIG. 18). However, the solution pH increased from 3 to 4 without buffer.

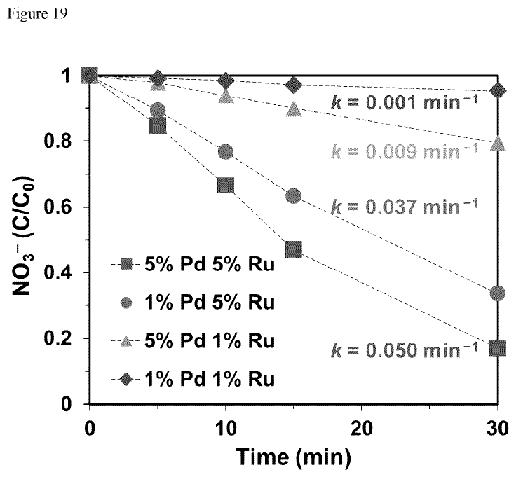

By keeping Pd content constant and reducing Ru content from 5% to 1%, the reaction rate only reduced by 26%. (FIG. 19).

### Salt Resistance of the Re-Based Catalysts.

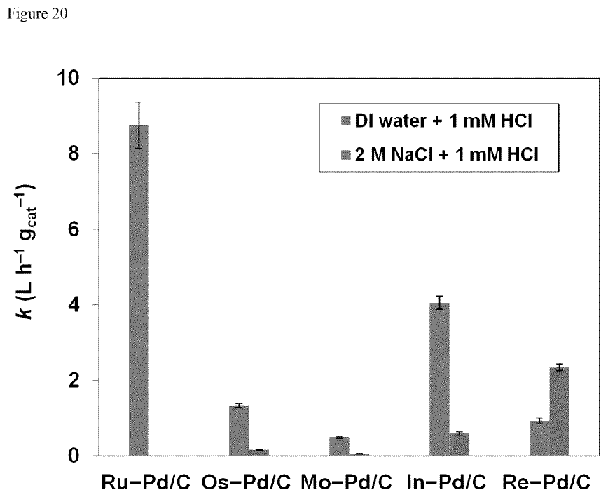

While Ru—Pd/C demonstrated superior activity in NO₃⁻ reduction, its performance is substantially hindered in concentrated salt solutions (FIG. 20). In stark contrast, the Re—Pd/C catalyst showed even higher activity in concentrated salt.

What is claimed is:

1. A catalyst comprising 1) Ru⁰ and 2) Pd⁰, Pt⁰, Rh⁰, or Ir⁰, on a solid support.

2. The catalyst of claim 1, which comprises Ru⁰ and Pd⁰ on a solid support.

3. The catalyst of claim 1, wherein the solid support comprises porous carbon, alumina, silica, a zeolite, a clay, TiO₂, CeO₂, ZrO₂, Mxene, a carbon nanotube, graphene, or biochar.

4. The catalyst of claim 1, which comprises highly dispersed Ru⁰.

5. The catalyst of claim 1, which can reduce ClO₃⁻ to Cl⁻ in water at a pH in the range from about 5 to about 8.

6. The catalyst of claim 1, which can reduce ClO₃⁻ to Cl⁻ in water at a pH of at least about 6.

7. The catalyst of claim 1, wherein the catalyst has a turnover number of at least 9,000 for ClO₃⁻.

8. The catalyst of claim 1, which has a turnover frequency of at least 10 ClO₃⁻ to Cl⁻:per minute:per Ru.

9. The catalyst of claim 1, comprises Ru⁰ and Pd⁰ on a support that comprises carbon, and which can reduce ClO₃⁻ to Cl⁻ in water at a pH in the range from about 5 to about 8, with a turnover frequency of at least 11 ClO₃⁻ to Cl⁻:per minute:per Ru.

10. A method comprising contacting a water sample that comprises ClO₃⁻ with a catalyst as described in claim 1, under conditions such that at least some of the ClO₃⁻ is reduced to Cl⁻.

11. The method of claim 10, which is carried out at a pH of at least about 7.

12. The method of claim 10, wherein the water sample further comprises sulfate.

13. A method comprising sequentially reducing 1) Pd^{II}, Pt^{II}, Rh^{III}, or Ir^{III} and 2) Ru^{III} on a support to provide a catalyst.

14. The method of claim 13, wherein Pd^{II} is reduced to Pd⁰ on a support that comprises carbon and Ru^{III} is reduced to Ru⁰ on the support to provide a Ru—Pd/C catalyst.

15. The method of claim 14, wherein the reducing is carried out at a temperature in the range from about 4° C. to about 25° C.

16. The method of claim 13, wherein the reducing is carried out under a mixture of an inert gas (e.g., N₂ or Ar) and H₂.

17. A method comprising contacting a water sample that comprises NO₃⁻ with a catalyst as described in claim 1, under conditions such that at least some of the NO₃⁻ is reduced to NH₄⁺.

18. A method comprising contacting a water sample that comprises NO₃⁻ with a catalyst that comprises in situ reduced Ru particles and another metal, under conditions such that at least some of the NO₃⁻ is reduced to NH₄⁺.

19. The method of claim 18, wherein the catalyst comprises Os—Ru/C, Ru—Ru/C, Ru—Rh/C, Ru—Ir/C, Ru—Pt/C or Ru—Pd/C.

20. A method comprising contacting a water sample that comprises NO₃⁻ with a catalyst that comprises Ru—Pd/C or In—Pd/C, under conditions such that at least some of the NO₃⁻ is reduced to NH₄⁺.
